(19) United States
(12) Patent Application Publication
(10) Pub. No.: US 2009/0020179 A1
(43) Pub. Date: Jan. 22, 2009

(54) Leakproof draft system pressure/vacuum relief device for power plants

(75) Inventor: Frederick Robert Rosse, Meadowbrook, PA (US)

Correspondence Address: Andover-IP-Law, Suite 300, 44 Park Street, Andover, MA, 01810, US

(73) Assignee: Washington Group International, Inc.

(21) Appl. No.: 12/217,795

(22) Filed: Jul. 9, 2008

Related U.S. Application Data
(60) Provisional application No. 60/959,896, filed on Jul. 17, 2007.

(51) Int. Cl. F16L 55/04

(52) U.S. Cl. 138/30; 138/26

(57) ABSTRACT

Methods and apparatus are disclosed for alleviating or modulating periodic sudden pressure changes in a gas ducting system by fluidically connecting a gas duct to one side of a partitioned, liquid-filled reservoir, the other side of which comprises a stack conduit venting to the ambient environment. With this configuration, elevated gas duct pressure displaces liquid from the reservoir up into the stack conduit to a height above the reservoir and thereby helps to alleviate the elevated duct or system pressure, without leaking process gases from the duct through the reservoir and into the environment. Reduced gas duct pressures or vacuum-like conditions in the duct draws ambient air through the stack conduit and the reservoir and then into the duct to help alleviate the reduced duct or system pressure.

### FIELD OF THE INVENTION

The present invention relates generally to apparatus for alleviating sudden positive or negative pressure changes in a gas ducting system, and, in a specific embodiment to a pressure/vacuum relief device to control potentially destructive boiler implosion conditions which can occur in conventional steam-electric power plants and to related methods for operating such devices, as well as to power plant and similar systems incorporating such devices.

### BACKGROUND OF THE INVENTION

Power plant boilers typically are subject to sudden, almost instantaneous fuel flow interruptions, or Main Fuel Trip (MFT), due to a multitude of safety and/or equipment protection reasons. When large boilers experience such a substantially instantaneous fuel flow interruption, the hot gasses exiting the furnace rapidly contract as the furnace and flue gas temperatures decay. At the same time, the system Induced Draft (ID) and Booster fans continue to force flue gas through and out of the system, with the result that a vacuum or at least partial vacuum condition can occur in the furnace, the boiler casing and/or the associated ductwork upstream of the fan(s). Destructively high vacuum conditions resulting from these factors have caused boiler casing failures and ductwork collapses at numerous power plant installations.

Conventional methods of accommodating these periodic high-vacuum conditions include the following:

A. Passive Protection. Passive protection is achieved by designing the boiler and ductwork to withstand the maximum negative pressure that could reasonably occur during a MIFT or similar incident.

B. Active protection. Active protection is achieved by rapidly arresting or reducing the fan's negative pressure-inducing capability. This is typically accomplished by closing the inlet dampers, closing the fan's inlet guide vanes, or changing the fan blade pitch for axial flow fans.

While the first method, i.e., designing all potentially vulnerable components to withstand the maximum anticipated transient pressure conditions, is generally effective, the expense is often excessive. For flue gas treatment system retrofits, in particular, re-design and stronger reinforcements for the boiler casing and ductwork may be considered prohibitively expensive and, therefore, often are not implemented.

The second method of control, i.e., active protection, is often sufficient, although this type of approach always involves compromise. For example, the repositioning of the large dampers or fan blades in the event of an incident requires a significant period of time, during which negative pressures continue to build. There are conditions that develop at some plants where unacceptable negative pressure transients result in spite of these control actions.

At some plants equipped with flue gas treatment retrofits, a vacuum relief path is maintained by connecting an abandoned plant chimney to the ducts between the ID Fans and the Booster Fans. This arrangement has the advantage of providing a ready path for vacuum relief, however, special features and close control are required to assure satisfactory operation. On the one hand, if the pressure in the ductwork is slightly positive, then untreated flue gas travels up the chimney; and, this gas flow must be continuously monitored, for example by a Continuous Emissions Monitoring System (CEMS), and reported as emissions. On the other hand, if the pressure in the ductwork is slightly negative, ambient air flows down the chimney into the flue gas ducts. With this scheme of vacuum relief protection, even normal and relatively common variations in fan pressures and outputs dictate that significant quantities of cool ambient air will be drawn essentially continuously into the system, thus producing potential corrosion issues, increasing the load on the Booster Fans, and increasing the load on the flue gas treatment system.

Placing a conventional check valve (or a mechanical blowoff panel or similar device) in an abandoned stack/chimney of the plant can allow vacuum relief while also preventing flue gas outleakage. Although this approach can solve the problem of vacuum relief as discussed above, practical design issues preclude use of ordinary check valves and similar devices in this type of application for the following reasons:

1. A standard check valve with moving parts would likely become seized or cemented in place due to continuous exposure to dirty flue gas and fly ash.

2. The check valve would have to be very large, on the order of several hundred square feet, to be effective in a typical power plant application.

3. The check valve would have to have low inertia, thereby allowing for very rapid opening operation to be effective.

4. The check valve would have to be substantially completely leakproof to preclude out-leakage of untreated flue gas.

5. The check valve would have to have virtually no leakage into the flue gas ducts with normal small pressure variations to preclude the problems associated with such leakage.

6. The check valve would have to have very high reliability, with long periods of no maintenance while operating in the flue gas environment.

7. Testing or verification of function would need to be available while the unit is in operation for long periods of time.

These and other problems with and limitations of the prior art in this field are addressed in whole, or at least in part, by the leakproof draft system vacuum relief device, the related methods of using such a device, and power plant systems incorporating such a device according to this invention.

### OBJECTS OF THE INVENTION

Accordingly, a general object of the present invention is to provide a leakproof draft system pressure/vacuum relief device useful for power plant and similar applications.

It is also a general object of this invention to provide apparatus and methods for rapidly and effectively alleviating transient conditions of either elevated pressure or reduced pressure/vacuum in gas flow systems and associated ductwork to prevent either leakage of process gases to the environment (which can occur under elevated pressure conditions) or damage to equipment (which can occur under vacuum conditions).

Another general object of this invention is to provide a low-cost, easily maintained flue gas pressure/vacuum relief device that is readily adaptable either to new plant construction or to retrofitting an existing plant.

A specific object of this invention is to provide a liquid loop seal pressure/vacuum relief device wherein liquid contained in a liquid reservoir separates a region in communication with the interior of a flue duct from the outside ambient environment.

Another specific object of this invention is to provide a liquid loop seal pressure/vacuum relief device including a liquid reservoir and a partition member in the reservoir configured such that a relatively high excess pressure condition on a flue gas side of the partition results in only slightly reducing the liquid level in the reservoir on the flue gas side of the partition.

Another specific object of this invention is to provide a liquid loop seal pressure/vacuum relief device including a liquid reservoir and a partition member in the reservoir configured such that a relatively small reduced pressure/vacuum condition on a flue gas side of the partition results in reducing the liquid level in the reservoir on the ambient environment side of the partition sufficiently to draw ambient air under the partition to the flue gas side to moderate the low pressure/vacuum condition.

Still another specific object of this invention is to provide a pressure/vacuum relief device with partition/wall member(s) having curved lip portion(s) configured to facilitate fluid flow in a first, inward direction while also retarding fluid flow in a second, outward direction.

Yet another specific object of this invention is to provide arrays of multiple pressure/vacuum relief modules according to the invention configured to maximize the vent relief capacity of a venting region of limited dimensions, such as an existing chimney.

These and other objects and advantages of the present invention will be apparent from the following description and the illustrative drawings as discussed below.

### SUMMARY OF THE INVENTION

The present invention comprises pressure/vacuum relief devices which are useful in controlling potentially destructive boiler implosion conditions which can occur in conventional steam-electric power plants, related methods for operating such devices, power plant systems incorporating such devices, and various other applications for such devices as described herein.

The pressure/vacuum relief devices of this invention effectively control the potentially destructive boiler implosion conditions which can occur in conventional steam-electric power plants. Such a device may be installed as a pressure/vacuum relief path section of the flue gas draft system of a new or existing conventional steam-electric plant. Applications for the devices of this invention include flue gas treatment system retrofits, where additional draft system fan capacity is to be added (for example, where Booster Fans are being added), and where the existing ductwork and boiler casings may not be designed to withstand the additional ductwork vacuum that typically occurs when new booster fans are added in these retrofits.

The pressure/vacuum relief device of this invention would generally be installed between the ID fans and the Booster fans of a power plant or similar system, where normal duct pressures are typically controlled to be at atmospheric pressure or close to atmospheric pressure. In the event of a Main Fuel Trip (MFT) event or other transient conditions which rapidly reduce flue gas flow, the destructive vacuum capability of the booster fan is ameliorated by a pressure/vacuum relief device according to this invention which allows ambient air to enter the ducts under such conditions.

The pressure/vacuum relief devices of this invention can be arranged to allow pressure/vacuum relief at any specified differential pressure between ambient conditions and the pressure in a duct section, such as in the duct section between the ID and the Booster fans of a power plant or similar system. The design of this invention also inhibits out-leakage of flue gas with substantially complete leakproof reliability for higher (and independently specified) differential pressures.

More specifically, a pressure/vacuum relief device according to this invention consists generally of a liquid loop seal separating the ambient environs from a selected section of the flue gas system by use of a water (or other liquid) loop seal. The geometry is arranged such that a specifically defined small vacuum in the selected section of the flue gas system will result in allowing copious amounts of ambient air to leak into a flue gas plenum region communicating with the selected section of the system experiencing the vacuum conditions by flowing such air under a loop seal partition. Conversely, if there is a flue gas pressure excursion, the geometry of a loop seal liquid reservoir and height of a vacuum vent stack and inlet lip are arranged such that venting of flue gas to the ambient environment is prevented. The loop seal is sized and configured so that it is capable of withstanding a large positive flue gas plenum differential positive pressure without allowing flue gas leakage under the loop seal partition. The differential positive pressure allowed before flue gas can leak into the atmosphere can be made several, e.g., five to ten, times larger than the vacuum relief differential. With this novel invention design, each type of potential plant breakdown differential pressure can be specified and designed for independently using a single pressure/vacuum relief system according to this invention.

The disadvantages and limitations of conventional check valve devices, as discussed above, are fully met and overcome by the pressure/vacuum relief devices of this invention. Continuous maintenance of negative ductwork pressures to preclude flue gas outleakage is not required with this invention, and the CEMS emissions considerations associated with other known pressure/vacuum relief protection devices are essentially completely eliminated. The pressure/vacuum relief devices of this invention have relatively low capital cost, significantly less than the comparable potential ductwork reinforcement costs for systems not capable of withstanding a particular desired level of applied transient vacuum conditions. The systems of this invention also have a significantly enhanced reliability when compared to other established methods of reducing boiler implosion ductwork vacuum conditions, and they are more effective in interrupting transient vacuum conditions.

More specifically, this invention comprises the following embodiments:

1. Apparatus for alleviating pressure changes in a gas ducting system, said apparatus comprising one or more pressure relief modules, each comprising: at least a container having a top edge, a bottom and sides, and containing a container liquid; said container being divided by a partition into first and second liquid regions having respectively first region and second region surfaces; said first region and second region surfaces communicating respectively with separate first and second gaseous regions; said first and second liquid regions are in fluid communication with one another only by means of liquid or gas passing under the partition; and, one of said first and second gaseous regions has a connection to provide fluid communication with said gas ducting system, and the other of said first and second gaseous regions has a connection to provide fluid communication with an environment external to said gas ducting system.

2. Apparatus according to paragraph 1 above, wherein the environment external to said gas ducting system is the ambient atmosphere.

3. Apparatus according to paragraph 1 above, wherein one of said first and second gaseous regions is connected to a duct section of a power generating plant.

4. Apparatus according to paragraph 1 above, wherein said container liquid is water.

5. Apparatus according to paragraph 1 above, wherein said partition comprises a dividing wall extending from above the top edge of the container partially into said container liquid.

6. Apparatus according to paragraph 5 above, further wherein said dividing wall comprises at a lower end thereof a lip which curves inward toward the liquid region on a gas-ducting system side of the container.

7. Apparatus according to apparatus 1 above, wherein the liquid region on an external environment side of the container is bounded by stack sidewalls that extend above the top edge of the container.

8. Apparatus according to paragraph 7 above, wherein at least one of said stack sidewalls comprises at an upper end thereof a lip which curves outward away from an external environment side of the container.

9. Apparatus according to paragraph 8 above, further wherein said partition comprises a dividing wall extending from above the top edge of the container partially into said container liquid, said dividing wall comprising at a lower end thereof a lip which curves inward toward the liquid region on a gas-ducting system side of the container.

10. Apparatus according to paragraph 1 above, wherein said first liquid region is on a gas-ducting side of the container, said second liquid region is on an external environment side of the container, and further wherein the area of said first region surface is substantially larger than the area of said second region surface.

11. Apparatus according to paragraph 1 above, said apparatus comprising a plurality of said pressure relief modules.

12. Apparatus according to paragraph 11 above, wherein at least two of said pressure relief modules share a common wall section.

13. Apparatus according to paragraph 11 above, wherein each of said pressure relief modules shares a common wall section with another such module.

14. Apparatus according to paragraph 11 above, wherein said partition comprises a dividing wall extending from above the top edge of the container partially into said container liquid, and wherein the liquid region on an external environment side of the container is bounded by stack sidewalls that extend above the top edge of the container, and further wherein the dividing wall of one pressure relief module also serves as a stack sidewall of another, vertically adjacent pressure relief module.

15. Apparatus according to paragraph 14 above, wherein the dividing wall comprises at a lower end thereof a lip which curves inward toward the liquid region on a gas-ducting system side of the container and also comprises at an upper end thereof a lip which curves outward away from an external environment side of the container.

16. Apparatus according to paragraph 11 above, wherein at least some of said plurality of pressure relief modules are configured in a partially overlapping vertical stack such that liquid from an upper container can be continuously cascaded into a lower container.

17. A gas ducting system capable of adapting to sudden positive or negative pressure changes in a duct carrying a flowing gas, said system comprising in combination:
(a) a duct for carrying flowing gas;
(b) at least a liquid reservoir containing a liquid, said reservoir including a divider element that divides the reservoir into a duct side and a vent side such that liquid or gas can pass under the divider element to move between the two sides of the reservoir;
(c) a gas conduit that connects the duct at a connection location to a region above the duct side of the reservoir; and,
(d) a stack conduit for carrying gas or liquid, said stack conduit extending generally vertically from the reservoir to above the top of the vent side of the reservoir, an upper end of the stack conduit being in fluid communication with the ambient atmosphere.

18. A gas ducting system according to paragraph 17 above further comprising an induced draft fan upstream of said connection location and a booster fan downstream of said connection location.

19. A gas ducting system according to paragraph 17 above wherein said system comprises a plurality of said liquid reservoirs, each having a region above a duct side of the reservoir that is fluidically connected to the duct.

20. A gas ducting system according to paragraph 19 above wherein the divider element of one reservoir also serves as at least a portion of the stack conduit of a vertically adjacent reservoir.

21. A power plant comprising a gas ducting system according to paragraph 17 above.

22. A method for alleviating pressure changes in a gas duct of a gas ducting system, said method comprising the steps of:
(a) providing at least a liquid reservoir containing a liquid, said reservoir including a divider element that divides the reservoir into a duct side and a vent side such that liquid or gas can pass under the divider element to move between the two sides of the reservoir;
(b) providing a stack conduit for carrying gas or liquid, said stack conduit extending generally vertically from the reservoir to above the top of the vent side of the reservoir, an upper end of the stack conduit being in fluid communication with the ambient atmosphere;
(c) fluidically coupling said gas duct to a region above the duct side of the reservoir; and,
(d) under elevated pressure conditions in the gas duct, flowing gas from the gas duct into the region above the duct side of the reservoir; or, alternatively, under reduced pressure conditions in the gas duct, flowing air from the ambient environment through the liquid reservoir and into the gas duct.

22. A method according to paragraph 22 above wherein said gas ducting system comprises an induced draft fan and a booster fan along the gas duct, and the gas duct is connected to said region above the duct side of the reservoir at a location downstream of the induced draft fan and upstream of the booster fan.

24. A method according to paragraph 22 above wherein step (a) comprises providing a plurality of the said liquid reservoirs, and step (c) comprises fluidically connecting the gas duct to the regions above the duct sides of each such reservoir.

25. A method according to paragraph 24 above further comprising the steps of providing said plurality of liquid reservoirs in a partially overlapping vertical stack, and cascading liquid from an upper reservoir into a lower reservoir.

### BRIEF DESCRIPTION OF THE DRAWINGS

FIG. 1 is an enlarged schematic cross-sectional illustration of an embodiment of a leakproof pressure/vacuum relief device according to this invention.

FIG. 2 is a schematic illustration of a portion of a flue gas draft system operating under normal pressure conditions while coupled to a pressure/vacuum relief device according to an embodiment of this invention.

FIG. 3 is a schematic illustration of a portion of a flue gas draft system operating under a transient elevated pressure condition while coupled to a pressure/vacuum relief device according to an embodiment of this invention.

FIG. 4 is a schematic illustration of a portion of a flue gas draft system operating under a transient reduced pressure/vacuum condition while coupled to a pressure/vacuum relief device according to an embodiment of this invention.

FIG. 5 is a schematic illustration of a portion of a flue gas draft system operating under normal pressure conditions while coupled to a pressure/vacuum relief system comprising an array of multiple individual pressure/vacuum relief modules each configured according to an embodiment of this invention.

FIG. 6 is an enlarged schematic cross-sectional illustration of an embodiment of a leakproof vacuum relief device according to this invention, generally similar to FIG. 1 but showing additional details.

### DESCRIPTION OF PREFERRED EMBODIMENTS OF THE INVENTION

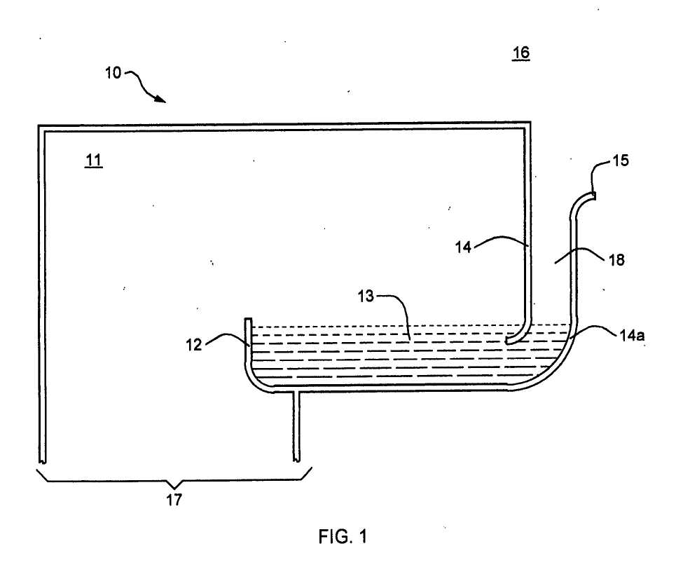

FIG. 1 is an enlarged schematic cross-sectional view illustrating the key features of a leakproof draft system pressure/vacuum relief device in accordance with this invention.

The pressure/vacuum relief device 10 as shown in FIG. 1 consists of a liquid loop seal 13 contained in a loop seal liquid reservoir 12, an upper portion of which is divided by a wall or divider or partition 14 into a larger gas-ducting side region and a smaller ambient environment side region. The wall or partition 14 extends at least from at or above the height of reservoir 12 partially into reservoir 12, but without sealing to the bottom of reservoir 12. Thus, liquid on the gas-ducting side of reservoir 12 can move under partition 14 into the ambient side of reservoir 12, and vice versa. The liquid loop seal 13 thereby separates the ambient environment 16 from a flue gas plenum region 11 and a duct connection 17 that communicates with a selected section of the flue gas system (not shown in FIG. 1) and inhibits gas leakage (air or flue gas respectively) into or out of the system. Water or other liquid may be used as the loop seal to fill reservoir 12. In a preferred embodiment, the geometry of the device is arranged such that a specifically defined and relatively small vacuum or below-ambient pressure in the flue gas system will allow copious amounts of ambient air to leak (via the ambient environment connection or vent stack conduit 18) into the flue gas plenum region 11 by flowing under the loop seal partition or inner wall section 14, which may comprise a lower lip portion in a preferred embodiment. Stack conduit 18 as shown in FIG. 1 is defined by an inner, partition wall portion 14 and by an outer wall portion 14a. In a preferred embodiment, outer wall portion 14a terminates at an inlet lip 15. Conversely, if there is a flue gas pressure excursion resulting in elevated (above ambient) pressure in the flue gas system, the geometry of the loop seal liquid reservoir 12 and height of the vacuum vent stack 18 and inlet lip 15 are designed and arranged such that venting of flue gas to the ambient environment is prevented. The loop seal can be readily designed to be capable of withstanding a relatively large differential positive pressure in the flue gas plenum 11 without allowing flue gas leakage. The amount of differential positive pressure that can be thus accommodated before flue gas could leak into the atmosphere can be made several times larger (e.g., four to ten times) than the vacuum relief differential pressure. Using the general apparatus design illustrated in FIG. 1, either type of possible breakdown differential pressure (i.e., positive or negative) can be specified and appropriately designed for independently.

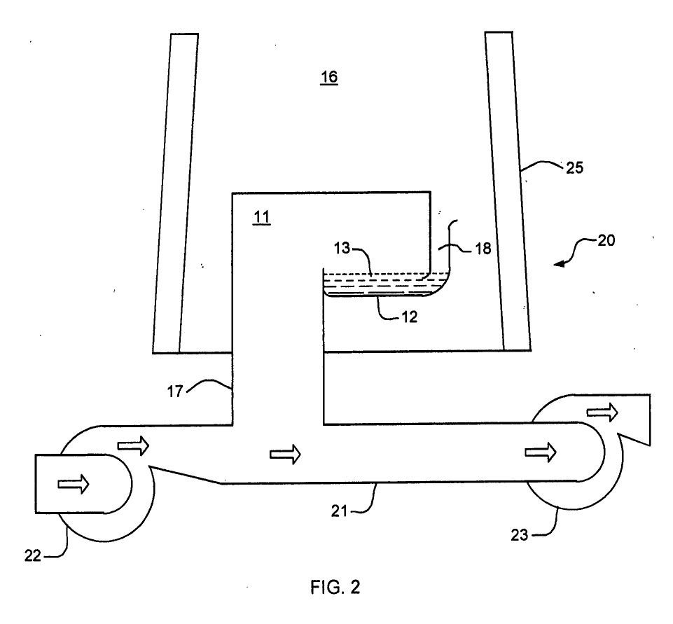

FIGS. 2, 3, and 4 are schematic cross-sectional views illustrating several typical apparatus arrangements and pressure conditions using a leakproof draft system vacuum relief device in accordance with this invention.

FIG. 2 schematically illustrates a combination apparatus 20 comprising a portion of a flue gas draft system equipped with a vacuum relief device according to this invention with the draft system operating under normal balanced pressure conditions, i.e., wherein the flue gas draft system is operating with no upsets that disturb system pressure conditions. As seen in FIG. 2, flue gas from a boiler or similar upstream flue gas source (not shown) flow through an induced draft fan 22, through flue gas duct 21, to a booster fan 23, and then on to a downstream treatment system (not shown). Fan controls maintain the flue gas pressure in the duct 21 connecting the induced draft fan 22 and the booster fan 23, substantially at atmospheric pressure. All of the gas flow (as indicated by the flow arrows) is from the plant induced draft fan 22 to the flue gas treatment system booster fan 23. There is no significant differential pressure between the flue gas duct 21 and the ambient environs 16, and there is substantially no gas flow to or from the flue gas vent connection 17. Thus, the levels of the loop seal liquid in reservoir 12 on the gas-ducting side of reservoir 12 and in stack conduit 18 on the ambient side of reservoir 12 are substantially identical. In this illustration, the pressure/vacuum relief device of this invention is shown located in an old chimney 25 of the plant.

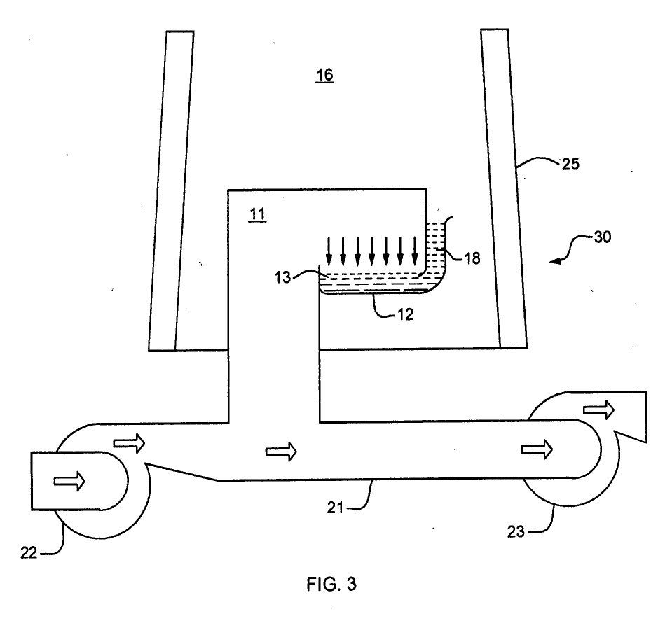

FIG. 3 schematically illustrates a combination apparatus 30 generally similar to FIG. 2 but, instead of normal operating conditions, comprising a portion of a flue gas draft system equipped with a vacuum relief device according to this invention with the draft system operating under a transient elevated pressure condition which would tend to cause untreated flue gas to escape to the atmosphere. Normal plant operating parameters as well as a variety of transient conditions may produce periods of positive pressure in the duct 21 between the fans 22, 23. Positive (elevated) pressure in the flue gas duct 21 forces flue gas through duct connection 17 (FIG. 1) and into the plenum region 11 of the pressure/vacuum relief device where such flue gas applies force to the surface of the liquid on the gas-ducting side of reservoir 12 (as illustrated by the downward pointing arrows) which, in turn, forces the liquid level in reservoir 12 to drop at least slightly and the liquid level in the stack conduit 18 of the device to correspondingly rise, thereby providing significant liquid pressure resisting the escape of any untreated flue gas from the flue gas plenum region 11. The geometry of the vacuum relief device of this invention may be easily configured based on familiar mathematical calculations to provide a robust loop seal in the outlet venting flow direction, sufficient to preclude the escape of any untreated flue gas within essentially any reasonably anticipated range of positive pressures. The differential positive pressure allowed before flue gas could leak into the atmosphere can be specified to essentially any desired value according to creditable experiential design basis events and/or based on mathematical modeling.

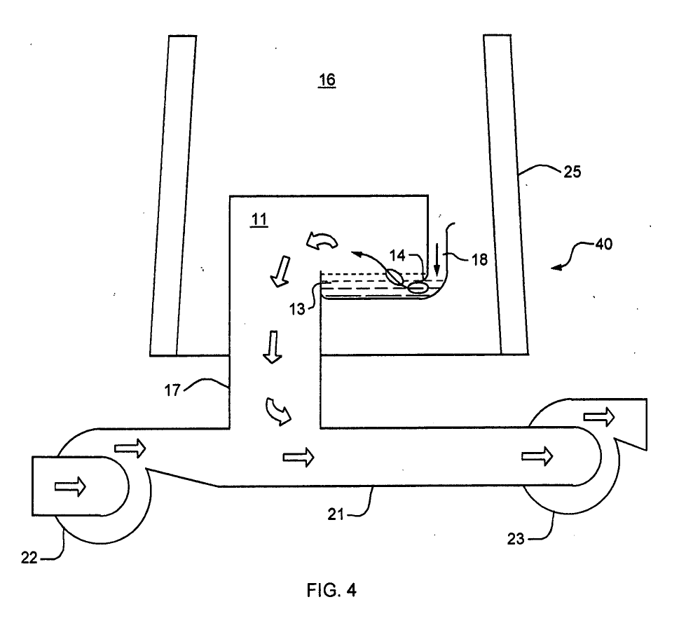

FIG. 4 schematically illustrates a combination apparatus 40 generally similar to FIG. 2 but, instead of normal operating conditions, comprising a portion of a flue gas draft system equipped with a vacuum relief device according to this invention with the draft system operating under a transient reduced pressure condition usually associated with a Main Fuel Trip (MFT), which would tend to cause excessive vacuum conditions within the plant ducts, boiler casing, and/or boiler furnace. Utilizing a pressure/vacuum relief system according to this invention, the plant draft system is protected from excessive duct vacuum by venting atmospheric air into the duct, thus preventing the buildup of excessive vacuum conditions between the two fans 22, 23, as well as reducing the buildup of vacuum conditions upstream of the induced draft fan 22. The vacuum relief device allows ambient air pressure to push the loop seal liquid downward in the stack conduit 18 from the atmospheric connection side of the device. When the liquid in the loop seal is pushed below the lowest part of the loop seal partition 14 which, as shown in FIG. 4, comprises one wall or side of the stack conduit 18, atmospheric air (as illustrated by the air bubbles) flows through the liquid 13 contained in the shallow liquid reservoir 12, then into the flue gas plenum region 11, through duct connection 17 (FIG. 1), and into duct 21, as indicated by the arrows in FIG. 4. This assures that the pressure in the flue gas plenum 11, in duct connection 17, and in duct 21 will remain essentially at atmospheric conditions. The geometry of the pressure/vacuum relief device may be easily configured based on familiar mathematical calculations to provide a relatively weak loop seal in the gas-ducting direction so as to preclude low pressure or vacuum conditions capable of collapsing ducts and boiler furnace panels from forming. The differential vacuum pressure at which vacuum relief occurs using the device of this invention can be specified to essentially any desired value as required for anticipated plant operating conditions.

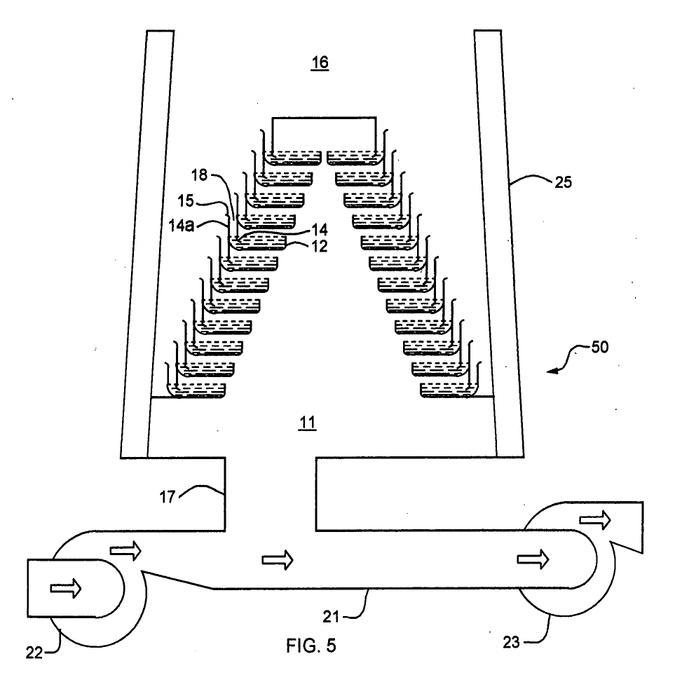

FIG. 5 schematically illustrates a combination apparatus 50 comprising a portion of a flue gas draft system equipped with multiple pressure/vacuum relief devices according to this invention in a typical arrangement as it might be applied to a power plant retrofit. Multiple pressure/vacuum relief units, each comprising a pressure/vacuum relief loop seal reservoir 12 and associated stack conduit 18, are located in a vent plenum region 11 (corresponding to flue gas plenum region 11 in FIG. 1) and are arranged to operate in parallel, thereby providing sufficient vent area capability as required by postulated transient MFT conditions for a particular application. Typical power plant chimneys, such as chimney 25, are about 50 feet in diameter, and the entire static pressure/vacuum relief apparatus according to this invention (comprising the set of multiple units) can be mounted within such a chimney. Individual loop seal liquid reservoirs 12 may be on the order of about 12 inches wide, and may be capable of being filled with liquid to a depth of a few inches, e.g., from about 3-10 inches. Each of the reservoirs 12 is formed as a long trough, ranging for example from about 20 or 30 feet in length. In a preferred mode of operation according to this invention, a continuous flow of cascading liquid from one reservoir 12 to the next lower reservoir 12 could be established to keep each liquid trough 12 filled to the proper level. This design and mode of operation would also continuously purge the loop seals of contaminants that might otherwise tend to accumulate. In this mode, the individual reservoirs 12 comprising a vertical stack of such units, as shown in FIG. 5, would be arranged and oriented to accommodate such a continuous cascading flow of liquid from an upper reservoir 12 to the next lower reservoir 12, and so on from the top of a stack to the bottom of the stack.

Additionally, the serial, progressively recessed stacking arrangement of individual loop seal modules as shown in FIG. 5 enables the inner partition wall 14 of a lower module to also double as the outer wall portion 14a/inlet lip 15 of the module directly above, a particularly efficient and space-saving configuration. In this configuration, wall portions 14 and 14a are the same single wall which serves as the inner wall 14 for a reservoir 12 of a first loop seal module and also as the outer wall 14a for the loop seal module located directly above the first module.

Individual pressure/vacuum relief loop seal modules (each comprising a reservoir 12 and at least a partition wall 14) can be fabricated and sized for shipping and installation convenience. Numerous other physical arrangements are possible, however, and it will be understood that FIG. 5 is intended only to give an idea of one particularly advantageous way in which a significant amount of vent area could be provided and arranged within a compact pre-existing or new space using pre-fabricated modules according to this invention.

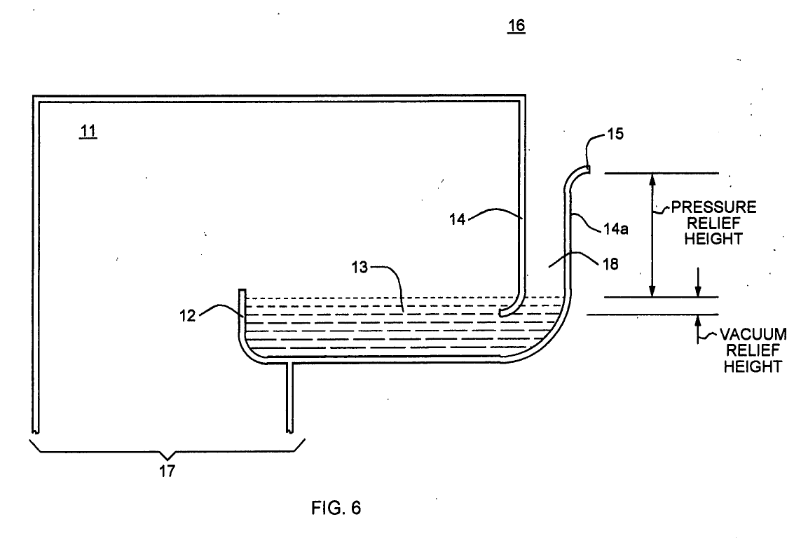

FIG. 6 illustrates an enlarged schematic cross-sectional view of the basic leakproof draft system pressure/vacuum relief device of this invention, similar to FIG. 1, but with additional design features delineated.

As shown in FIG. 6, the liquid reservoir 12 is preferably configured to present a relatively large surface area to the gas-ducting side of the liquid loop seal 13. Thus, increasing pressure on the gas-ducting side may push the liquid level in that part of reservoir 12 in the downward direction only slightly while nevertheless substantially filling the liquid stack 18 on the opposite (external environment) side of the loop seal to the pressure relief height (i.e., the height that results in sufficient modulation of the pressure increase), for example, as illustrated in FIG. 3. This configuration creates a high resistance to the escape of untreated flue gas to the atmosphere. By contrast, under low pressure/vacuum conditions in the power plant system, the amount of liquid that needs to be downwardly displaced on the external environment side in order to produce “breakthrough” vacuum venting through stack conduit 18 is very small and does not significantly raise the liquid level on the gas-ducting side of the loop seal liquid reservoir 12, for example, as illustrated in FIG. 4.

As also shown in FIG. 6, the geometry may be arranged to favor flow into the flue gas plenum with minimum flow friction. The outwardly-curved shape of the vacuum vent inlet lip 15, and the inwardly-curved shape of the lip at the lower portion of the loop seal partition 14 offer low frictional resistance for inlet air flow in the vacuum venting direction. In the stacked, multiple pressure/vacuum relief unit assembly illustrated in FIG. 5, where a wall portion 14, 14a serves both as an inner wall (14) for one module and as an outer wall (14a) for a vertically adjacent module, each such wall portion would preferably include a lower lip (as seen in FIG. 1 for inner wall 14) and also an upper lip 15 (as seen in FIG. 1 for outer wall 14a). Conversely, flue gas flow in the opposite direction, occurring during elevated pressurization events, experiences a higher frictional resistance because of the inwardly-facing curved partition lip at the lower end of wall 14, which is usually desirable.

The pressure/vacuum relief devices herein described provide a reliable and simple barrier to leakage of untreated flue gas to the environment, while also providing reliable assurance that unacceptable low pressure/vacuum conditions in associated flue-gas ductwork are prevented. Pressure/vacuum relief modules according to this invention can be built of lightweight sheet metal construction, for example of thin stainless sheet material, similar to that used for commercial kitchen equipment. The capability of these devices to withstand operating pressures would only typically need to be on the order of several inches water column, which is much less than the design pressures of the ducts which the pressure/vacuum relief devices of this invention are intended to protect.

In practice, analysis and simulation of furnace draft system transient response would be performed to tailor system parameters according to plant specifics. Similar analysis and simulation is routinely performed in the industry for all major draft system retrofit work, so the calculation/selection of such system parameters for a particular application is well within the ability of one skilled in this art based on the teachings contained herein.

The pressure/vacuum relief devices of this invention have no moving parts and use technical principles which are well established. Adequate vent area, with no significant inertial delay (an important consideration for rapid transients), can be easily provided using the apparatus and methods of this invention.

Maintenance and cleaning of the device is also very easy, consisting essentially of periodically flushing the liquid reservoirs. Assurance of functional readiness consists of verification that water troughs are filled with water or other suitable liquid. By arranging for cascading water flow from a higher elevation trough to the next lower trough in a series of progressively recessed overlapping reservoirs, continuous series flushing/filling can be assured. Moreover, these steps can be accomplished while the plant and the pressure/vacuum relief system are online.

With the apparatus and methods of this invention, continuous maintenance of ductwork negative pressures to preclude flue gas out-leakage is not required, and the CEMS emissions considerations commonly associated with other vacuum relief protection devices are completely eliminated.

While this invention has been described for typical power plant flue gas treatment system retrofit projects, the same principles can be applied to any number of other ductwork systems where it is desirable to provide implosion or overpressure protection with reliable leakproof barriers to gas flow. Because the “breakthrough” pressure of the devices of this invention, for vent flow in either direction, can be established independently at any value desired, several other common industrial applications could also benefit from this technology. A few examples of such other applications for this invention include industries dealing with potentially contaminated gas streams, such as food or pharmaceutical processing operations, as well as industries handling toxic or reactive gasses, such as combustion gas processing plants, chemical demilitarization operations, etc.

Although this invention has been described by reference to specific embodiments thereof, and by reference to particular geometries of component parts, it will be understood by those skilled in this art that this description was for illustrative purposes and that various changes and modifications may be made in the apparatus components, configuration of the components, and other invention details without departing from the spirit and scope of this invention.

Having described the invention, what is claimed is:

1. Apparatus for alleviating pressure changes in a gas ducting system, said apparatus comprising one or more pressure relief modules, each comprising: at least a container having a top edge, a bottom and sides, and containing a container liquid; said container being divided by a partition into first and second liquid regions having respectively first region and second region surfaces; said first region and second region surfaces communicating respectively with separate first and second gaseous regions; said first and second liquid regions are in fluid communication with one another only by means of liquid or gas passing under the partition; and, one of said first and second gaseous regions has a connection to provide fluid communication with said gas ducting system, and the other of said first and second gaseous regions has a connection to provide fluid communication with an environment external to said gas ducting system.

2. Apparatus according to claim 1, wherein the environment external to said gas ducting system is the ambient atmosphere.

3. Apparatus according to claim 1, wherein one of said first and second gaseous regions is connected to a duct section of a power generating plant.

4. Apparatus according to claim 1, wherein said container liquid is water.

5. Apparatus according to claim 1, wherein said partition comprises a dividing wall extending from above the top edge of the container partially into said container liquid.

6. Apparatus according to claim 5, further wherein said dividing wall comprises at a lower end thereof a lip which curves inward toward the liquid region on a gas-ducting system side of the container.

7. Apparatus according to claim 1, wherein the liquid region on an external environment side of the container is bounded by stack sidewalls that extend above the top edge of the container.

8. Apparatus according to claim 7, wherein at least one of said stack sidewalls comprises at an upper end thereof a lip which curves outward away from an external environment side of the container.

9. Apparatus according to claim 8, further wherein said partition comprises a dividing wall extending from above the top edge of the container partially into said container liquid, said dividing wall comprising at a lower end thereof a lip which curves inward toward the liquid region on a gas-ducting system side of the container.

10. Apparatus according to claim 1, wherein said first liquid region is on a gas-ducting side of the container, said second liquid region is on an external environment side of the container, and further wherein the area of said first region surface is substantially larger than the area of said second region surface.

11. Apparatus according to claim 1, said apparatus comprising a plurality of said pressure relief modules.

12. Apparatus according to claim 11, wherein at least two of said pressure relief modules share a common wall section.

13. Apparatus according to claim 11, wherein each of said pressure relief modules shares a common wall section with another such module.

14. Apparatus according to claim 11, wherein said partition comprises a dividing wall extending from above the top edge of the container partially into said container liquid, and wherein the liquid region on an external environment side of the container is bounded by stack sidewalls that extend above the top edge of the container, and further wherein the dividing wall of one pressure relief module also serves as a stack sidewall of another, vertically adjacent pressure relief module.

15. Apparatus according to claim 14, wherein the dividing wall comprises at a lower end thereof a lip which curves inward toward the liquid region on a gas-ducting system side of the container and also comprises at an upper end thereof a lip which curves outward away from an external environment side of the container.

16. Apparatus according to claim 11, wherein at least some of said plurality of pressure relief modules are configured in a partially overlapping vertical stack such that liquid from an upper container can be continuously cascaded into a lower container.

17. A gas ducting system capable of adapting to sudden positive or negative pressure changes in a duct carrying a flowing gas, said system comprising in combination:
(a) a duct for carrying flowing gas;
(b) at least a liquid reservoir containing a liquid, said reservoir including a divider element that divides the reservoir into a duct side and a vent side such that liquid or gas can pass under the divider element to move between the two sides of the reservoir;
(c) a gas conduit that connects the duct at a connection location to a region above the duct side of the reservoir; and,
(d) a stack conduit for carrying gas or liquid, said stack conduit extending generally vertically from the reservoir to above the top of the vent side of the reservoir, an upper end of the stack conduit being in fluid communication with the ambient atmosphere.

18. A gas ducting system according to claim 17 further comprising an induced draft fan upstream of said connection location and a booster fan downstream of said connection location.

19. A gas ducting system according to claim 17 wherein said system comprises a plurality of said liquid reservoirs, each having a region above a duct side of the reservoir that is fluidically connected to the duct.

20. A gas ducting system according to claim 19 wherein the divider element of one reservoir also serves as at least a portion of the stack conduit of a vertically adjacent reservoir.

21. A power plant comprising a gas ducting system according to claim 17.

22. A method for alleviating pressure changes in a gas duct of a gas ducting system, said method comprising the steps of:
(a) providing at least a liquid reservoir containing a liquid, said reservoir including a divider element that divides the reservoir into a duct side and a vent side such that liquid or gas can pass under the divider element to move between the two sides of the reservoir;
(b) providing a stack conduit for carrying gas or liquid, said stack conduit extending generally vertically from the reservoir to above the top of the vent side of the reservoir, an upper end of the stack conduit being in fluid communication with the ambient atmosphere;
(c) fluidically coupling said gas duct to a region above the duct side of the reservoir; and,
(d) under elevated pressure conditions in the gas duct, flowing gas from the gas duct into the region above the duct side of the reservoir; or, alternatively, under reduced pressure conditions in the gas duct, flowing air from the ambient environment through the liquid reservoir and into the gas duct.

23. A method according to claim 22 wherein said gas ducting system comprises an induced draft fan and a booster fan along the gas duct, and the gas duct is connected to said region above the duct side of the reservoir at a location downstream of the induced draft fan and upstream of the booster fan.

24. A method according to claim 22 wherein step (a) comprises providing a plurality of the said liquid reservoirs, and step (c) comprises fluidically connecting the gas duct to the regions above the duct sides of each such reservoir.

25. A method according to claim 24 further comprising the steps of providing said plurality of liquid reservoirs in a partially overlapping vertical stack, and cascading liquid from an upper reservoir into a lower reservoir.
